(19) United States
(12) Patent Application Publication
(10) Pub. No.: US 2016/0297441 A1
(43) Pub. Date: Oct. 13, 2016

(54) SYSTEM AND METHOD FOR MACHINE COST OPTIMIZATION

(71) Applicant: Caterpillar Inc., Peoria, IL (US)

(72) Inventor: Keith D. Hogan, Peoria Heights, IL (US)

(73) Assignee: Caterpillar Inc., Peoria, IL (US)

(21) Appl. No.: 15/188,520

(22) Filed: Jun. 21, 2016

(51) Int. Cl. B60W 30/188; G06Q 50/06; G06Q 10/06

(52) U.S. Cl. CPC B60W 30/188; G06Q 10/06315; G06Q 50/06; B60W 2710/06

(57) ABSTRACT

A cost optimization system for optimizing costs of consumables for a machine is provided. The cost optimization system includes an input module configured to receive cost information relating to a unit cost of each of a plurality of consumables. A control module is communicably coupled to the input module. The control module is configured to receive the cost information from the input module. Further, the control module is configured to monitor one or more parameters of the machine. The control module is configured to control operation of the machine based on the one or more parameters to control use of the plurality of consumables to optimize the machine operating costs.

### TECHNICAL FIELD

The present disclosure relates to a cost optimization system for a machine, and more specifically, to a system for optimizing costs of consumables for the machine.

### BACKGROUND

Machines such as mining trucks, or wheel loaders are used for performing various operations. Typically, the machines have various operating parameters such as, but not limited to, an engine speed and an engine load for proper operation of the machine. During the operation of the machine, an operating cost of the machine may be determined based on a cost of the consumables and a rate of consumption of the consumables. The consumables include, but are not limited to, fuel, and diesel exhaust fluid (DEF).

Currently, the operating cost of the machine may vary with a change in the cost of the consumables and/or the change in the rate of consumption of the consumables. For example, any change in the cost of the consumables may result in variation in operating costs for the machine.

U.S. Pat. No. 9,103,248 describes a system for optimizing fuel and reductant consumption. An operation mode of an engine and an after-treatment system is determined based on a reductant-to-fuel cost ratio. The operation mode optimizes fuel consumption and reductant consumption in an engine system. The engine system includes an internal combustion engine and a selective catalytic reduction (SCR) catalyst while satisfying a target emission level.

However, known solutions may not provide ways of controlling an operation of the machine to optimize running cost of the machine. Therefore, there is a need for an improved cost optimization system for the machine.

### SUMMARY OF THE DISCLOSURE

In one aspect of the present disclosure, a cost optimization system for optimizing costs of consumables for a machine is provided. The cost optimization system includes an input module configured to receive cost information relating to a unit cost of each of a plurality of consumables. A control module is communicably coupled to the input module. The control module is configured to receive the cost information from the input module. Further, the control module is configured to monitor one or more parameters of the machine. The control module is configured to control operation of the machine based on the one or more parameters to control use of the plurality of consumables to optimize the machine operating costs.

Other features and aspects of this disclosure will be apparent from the following description and the accompanying drawings.

### BRIEF DESCRIPTION OF THE DRAWINGS

FIG. 1 is a side view of an exemplary machine, in accordance with the concepts of the present disclosure;

FIG. 2 is a side view of another exemplary machine, in accordance with the concepts of the present disclosure;

FIG. 3 is a block diagram of a cost optimization system for optimizing costs of consumables for the machines of FIGS. 1 and 2, in accordance with the concepts of the present disclosure; and

FIG. 4 is a flowchart of a method for optimizing costs of the consumables for the machines of FIGS. 1 and 2, in accordance with the concepts of the present disclosure.

### DETAILED DESCRIPTION

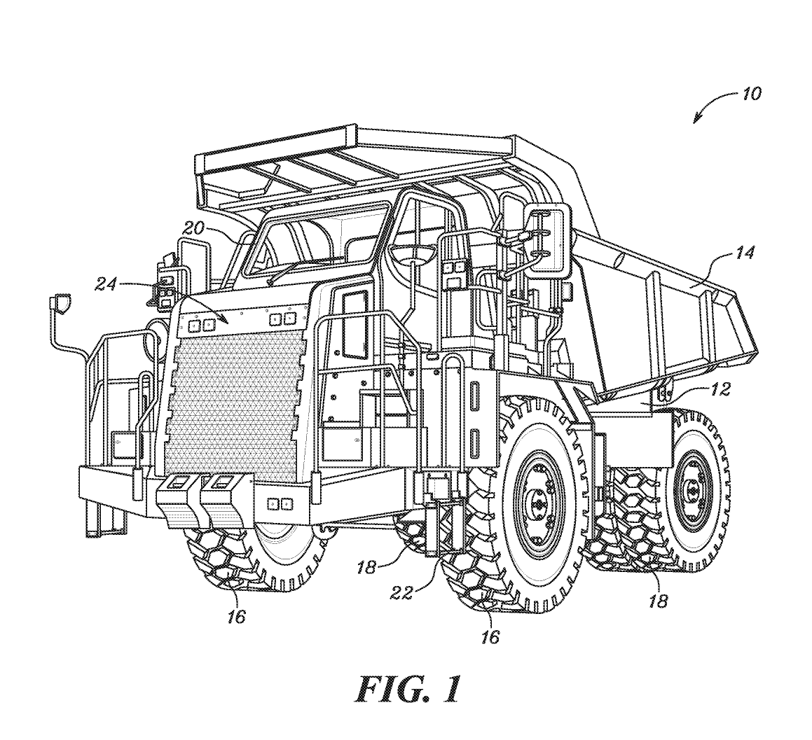

Referring to FIG. 1, an exemplary machine 10 is illustrated. The machine 10 is used for various operations such as, but not limited to, mining operations. The machine 10 includes a frame 12 and a dump body 14. The dump body 14 is pivotally mounted on the frame 12, and is utilized for carrying material or load. Further, the dump body 14 may be tilted between a lowered position and a lifted position, using a hydraulic actuator (not shown). The hydraulic actuator utilizes hydraulic fluid energy to support raising and lowering of the dump body 14. Further, the machine 10 is supported on a ground surface by a first set of tires 16 and a second set of tires 18.

The machine 10 further includes an operator cab 20 which has a driver seat (not shown) for an operator to be seated. The operator cab 20 is accessed by steps 22. Further, the machine 10 includes an engine assembly 24 which has an engine (not shown). The engine is configured to provide power to the machine 10.

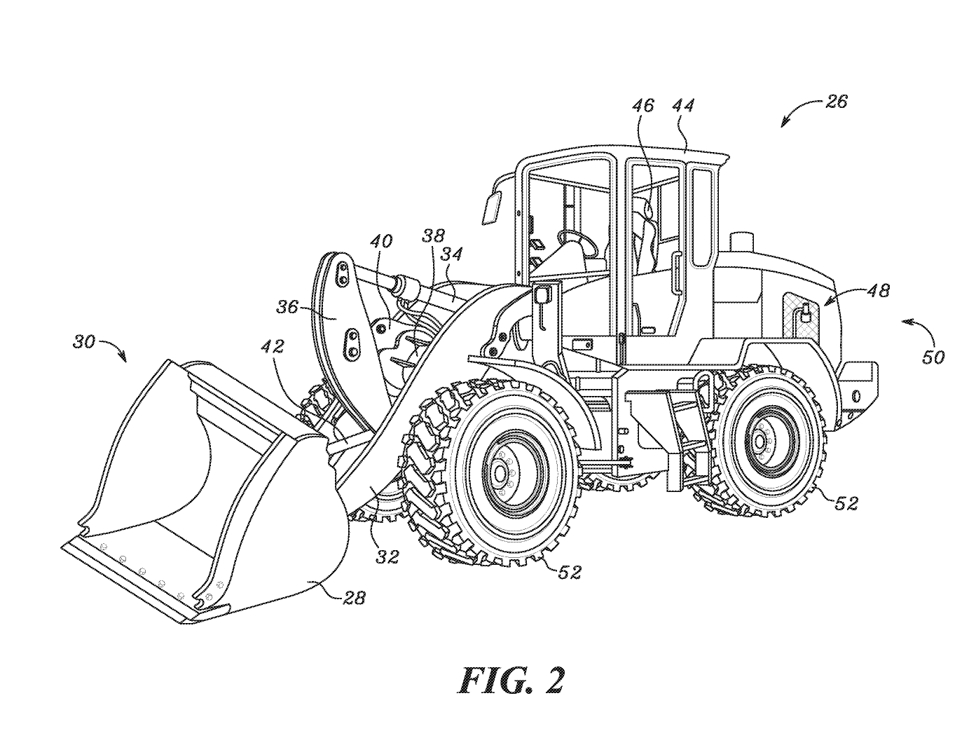

Referring to FIG. 2, another exemplary machine 26 is illustrated. The machine 26 is used for various operations such as, but not limited to, grading of land, or loading and transportation of materials. The machine 26 includes a bucket 28 which is disposed at a first end 30 of the machine 26. The bucket 28 is utilized for loading the materials. It should be noted that the height of the bucket 28 is varied by varying height of booms 32. Further, the orientation of the bucket 28 is varied by retracting and expanding length of a hydraulic cylinder 34. The hydraulic cylinder 34 is coupled to a bucket bellcrank 36. The bucket bellcrank 36 is pivotally coupled to a bar 38 which is disposed between the booms 32, using a joint member 40. Further, the bucket bellcrank 36 is coupled to a linkage 42, and oscillates around the joint member 40 to change the orientation of the bucket 28 with the help of the linkage 42.

The machine 26 further includes an operator cab 44 which has a driver seat 46 for an operator to be seated. Further, the machine 26 includes an engine assembly 48 which is disposed at a second end 50 of the machine 26. The engine assembly 48 includes an engine (not shown) which is configured to provide power to the machine 26. Further, the machine 26 includes a number of tires 52.

It will be apparent to one skilled in the art that the machines 10, 26 shown in FIGS. 1 and 2 respectively are exemplary machines. Alternatively, the machines 10, 26 may embody a wheel dozer, articulated trucks, or any other machine capable of carrying or transporting the load from one place to another, without departing from the scope of the disclosure.

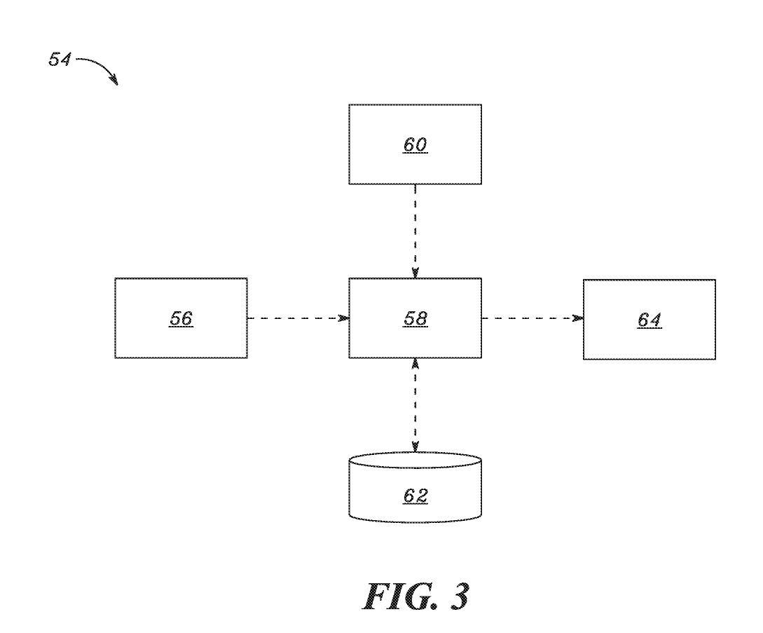

Referring to FIG. 3, a cost optimization system 54 is illustrated for use with any one or both of the machines 10, 26. The cost optimization system 54 includes an input module 56 which is configured to receive cost information relating to a unit cost of each of a number of consumables for the machines 10, 26. The consumables include, but are not limited to, fuel, and diesel exhaust fluid (DEF). In an embodiment, the consumables may include engine oil. It should be noted that cost of the engine oil may be included in the cost of the fuel. For example, a unit cost of the fuel is US dollar 3.04 per gallon and a unit cost of the diesel exhaust fluid (DEF) is US dollar 5.78 per gallon. It will be apparent to one skilled in the art that the consumables mentioned above have been provided only for explanation purposes, without departing from the scope of the disclosure.

The input module 56 may be disposed at various locations such as, within each of the machines 10, 26 in a case of a single machine or at a remote location (not shown) in a case of a fleet of machines. Further, the cost information relating to the unit cost of each of the consumables may be input by an operator. As an example, in the case of the single machine, the operator may feed the cost information relating to the unit cost of each of the consumables into the respective machines 10, 26. In another example, in the case of the fleet of the machines, the operator may input the cost information relating to the unit cost of each of the consumables at the remote location. Alternatively, the cost information may be input automatically by a management information system (MIS) or any other system to account for changes or fluctuations in the unit cost of the consumables on a real-time basis.

The cost optimization system 54 further includes a control module 58 which is communicably coupled to the input module 56. The control module 58 is configured to receive the cost information relating to the unit cost of each of the consumables from the input module 56. The control module 58 is configured to monitor a number of parameters of the machines 10, 26. The parameters include, but are not limited to engine parameters and/or load based parameters. The engine parameters correspond to parameters related to an operation of the engine drivingly engaged to the respective machine 10, 26. Examples of the engine parameters include, but are not limited to, an engine speed. On the other hand, the load based parameters include parameters associated with handling payload/materials carried by the respective machines 10, 26. Examples of the load based parameters include, but are not limited to, an engine load. It will be apparent to one skilled in the art that the parameters mentioned above have been provided only for explanation purposes, and may also use any other parameters/attributes that may contribute to operating costs of the machine 10, 26, without departing from the scope of the disclosure.

Further, the control module 58 is communicably coupled with a number of sensors 60. The sensors 60 are provided on-board the respective machines 10, 26, and are configured to generate a signal indicative of consumption and/or a rate of consumption of the consumables according to the current operating conditions of the respective machines 10, 26. Examples of the sensors 60 include, but not limited to, engine sensors, load sensors, or DEF sensors. Alternatively, gauges (not shown) may be provided on-board the respective machines 10, 26. As an example, a gauge such as a fuel gauge may determine the rate of consumption of the fuel in the respective machines 10, 26. The rate of consumption of the consumables may be indicative of a current utilization of the consumables by the machines 10, 26 during the operation of the respective machines 10, 26. Generally, a rate of consumption of the fuel is inversely related to a rate of consumption of the diesel exhaust fluid (DEF). It should be noted that an operating cost of the machines 10, 26 may be estimated based on the unit cost of the consumables and the consumption of the consumables.

Further, the control module 58 maps the rate of consumption of the consumables and/or the cost information with engine control maps which are stored in a database 62. The database 62 is communicably coupled to the control module 58 and stores the cost information and rate of consumption of the consumables associated with the respective machines 10, 26. The engine control maps indicate data related to the rate of consumption of the consumables against the parameters of the machines 10, 26 based on the current operating conditions. The data is pre-stored in the engine control maps, and the engine control maps include lookup tables, reports or any other external source or repository associated with the respective machines 10, 26, without departing from the scope of the disclosure. It should be noted that above mentioned mapping may be a comparison or a correlation. As an example, the correlation may be a mathematical relationship or equation among the parameters, the cost information, and the rate of consumption of the consumables.

Based on the mapping among the parameters, the cost information, and the rate of consumption of the consumables, the control module 58 controls operations of the respective machines 10, 26 to optimize the operating costs of the machines 10, 26. It should be noted that the control module 58 is further communicably coupled to an engine control module (ECM) 64. The engine control module 64 is provided on-board of each of the machines 10, 26, and is configured to control the operations of the respective machines 10, 26. The operation of the machines 10, 26 includes, but not limited to, control the engine parameters such as the engine speed or the engine load. In an embodiment, the control module 58 may control uses of the fuel and the diesel exhaust fluid (DEF) to optimize total costs of the operation of the machines 10, 26, based on a comparison of individual costs of the fuel and the diesel exhaust fluid (DEF) and the consumption of the fuel and the diesel exhaust fluid (DEF). As an example, if the control module 58 controls usage of the fuel, then the machine 10 or 26 may run an engine cooler in such a manner that optimizes utilization of the diesel exhaust fluid (DEF). Further, material handling capability of the machine 10, or 26 is reduced and thus the machine 10, or 26 digs up lesser load (i.e., ¾^{th} load as compared to if more fuel is used). In another example, if the control module 58 controls usage of the diesel exhaust fluid (DEF), then the machine 26 may run an engine hotter, and thus handles more payloads.

It should be noted that in the case of the fleet of the machines, the engine control module 64 of each of the respective machines 10, 26 receives commands from the control module 58 for controlling the operation of each of the machines 10, 26 in order to optimize operating costs of the machines 10, 26. The commands may be indicative of control use of the consumables based on a comparison of the individual cost of the fuel and the diesel exhaust fluid (DEF), or control the parameters such as the engine speed and the engine load of the respective machines 10, 26. As an example, in the case of the fleet of the machines at a worksite, the control module 58 controls the operation of the machine 10 in a certain way, and the operation of the machine 26 in a different way to optimize the total operating costs of all machines at the worksite.

Further, the control module 58 notifies the operator regarding a real time run cost of the machines 10, 26 and the parameters such as the engine speed and the engine load for the operation of the machines 10, 26. It should be noted that the control module 58 notifies the operator on devices such as, but not limited to, a personal computer, a mobile, a television, a pager, a display device, or a tablet. Alternatively, the control module 58 may notify the operator via an audio output or any other combination of a visual and auditory output.

It should be noted that the control module 58 mentioned above may embody a single microprocessor or multiple microprocessors. Numerous commercially available microprocessors can be configured to perform the functions of the control module 58. It should be appreciated that the control module 58 could readily be embodied in a general machine microprocessor capable of controlling numerous machines 10, 26 functions. The control module 58 may include a memory, a secondary storage device, a processor, and any other components for running an application. Various other circuits may be associated with the control module 58 such as power supply circuitry, signal conditioning circuitry, solenoid driver circuitry, and other types of circuitry.

### INDUSTRIAL APPLICABILITY

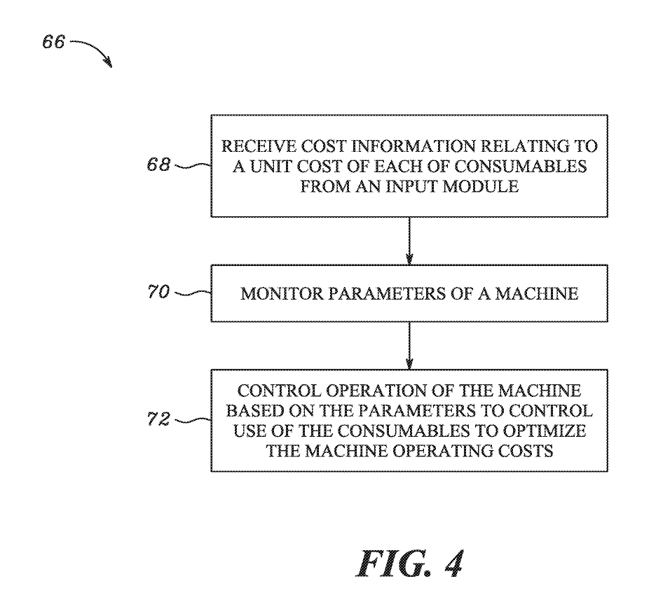

Referring to FIG. 4, a method 66 for optimizing the costs of the consumables for the machines 10, 26 is illustrated.

At step 68, the cost information relating to the unit cost of each of the consumables is received by the control module 58 from the input module 56. The consumables include the fuel and the diesel exhaust fluid. At step 70, the parameters of the machines 10, 26 are monitored by the control module 58. The parameters of the machines 10, 26 include the engine parameters and/or the load based parameters. At step 72, the operation of the machines 10, 26 are controlled by the control module 58 based on the parameters to control use of the consumables to optimize the operating costs of the machines 10, 26.

The present disclosure provides the cost optimization system 54 for optimizing costs of the consumables for the machines 10, 26. The cost optimization system 54 is an automatic system that receives the cost information relating to the unit cost of the consumables and monitors the parameters of the respective machines 10, 26 to control operation of the respective machines 10, 26. Thereafter, the cost optimization system 54 controls use of the consumables to optimize the total operating costs of each of the machines 10, 26. Further, the cost optimization system 54 notifies the operator regarding a real time run cost of the machines 10, 26, and operating parameters of the machines 10, 26.

Additionally, the cost optimization system 54 provides a real time feedback control for controlling the parameters of the machines 10, 26. Further, the cost optimization system 54 enables cost savings, by determining the operating parameters for the machines 10, 26. Also, the cost optimization system 54 is an efficient, and a cost-effective solution for optimizing the operating costs of the machines 10, 26. While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A cost optimization system for optimizing costs of consumables for a machine, the cost optimization system comprising:
an input module configured to receive cost information relating to a unit cost of each of a plurality of consumables; and
a control module communicably coupled to the input module, the control module configured to:
receive the cost information from the input module;
monitor one or more parameters of the machine; and
control operation of the machine based on the one or more parameters to control use of the plurality of consumables to optimize the machine operating costs.

2. The cost optimization system of claim 1, wherein the plurality of consumables include fuel and diesel exhaust fluid (DEF).

3. The cost optimization system of claim 2, wherein the control module controls use of the fuel and the DEF to optimize total costs of the machine operation based on a comparison of individual costs of the fuel and the DEF.

4. The cost optimization system of claim 1, wherein the one or more parameters of the machine includes one or more parameters related to operation of an engine drivingly engaged to the machine.

5. The cost optimization system of claim 1, wherein the one or more parameters of the machine includes one or more parameters related to a load being controlled by the machine.
